(19) United States
(12) Patent Application Publication
(10) Pub. No.: US 2006/0022602 A1
(43) Pub. Date: Feb. 2, 2006

(54) Method and apparatus for driving plasma display panel

(75) Inventor: Jung Gwan Han, Kumi-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/180,909

(22) Filed: Jul. 14, 2005

(30) Foreign Application Priority Data
Jul. 16, 2004 (KR) 2004-55372

(51) Int. Cl. G09G 3/10

(52) U.S. Cl. 315/169.1

(57) ABSTRACT

A method and apparatus for driving a plasma display panel is disclosed which can prevent the occurrence of erroneous discharge causing generation of bright defects. In accordance with the method and apparatus, the time interval between a final sustain pulse finally applied in a sustain period and a sustain pulse immediately preceding the final sustain pulse is set to be in a range of 0.1 μs to 1.0 μs, to reduce the amount of wall discharges erased during a period in which a low-level voltage is simultaneously applied to scan and sustain electrodes. Accordingly, the driving margin of the erasing discharge occurring in the next erasing address period is widened. Thus, it is possible to prevent the occurrence of erroneous discharge in the OFF cell, and thus, generation of bright defects, thereby achieving an enhancement in the display quality of the plasma display panel.

### BACKGROUND OF THE INVENTION

1. Field of the Invention

The present invention relates to a method and apparatus for driving a plasma display panel, and, more particularly, to a method and apparatus for driving a plasma display panel in accordance with a selective erasing method, which can stabilize erasing address discharge during operation of the plasma display panel according to the selective erasing method, thereby preventing the occurrence of erroneous discharge causing generation of bright defects.

2. Description of the Related Art

Plasma display panels display an image including text or graphics by causing phosphors to emit light using vacuum ultraviolet (VUV) rays with a wavelength of 147 nm generated during discharge of HE+Xe, Ne+Xe, or He+Ne+Xe gas. Such a plasma display panel not only can easily achieve desired thinness and desired large size, but also can achieve a great enhancement in picture quality owing to the recent technical development thereof.

An example of such a plasma display panel is a three-electrode alternating current (AC) surface discharge type plasma display panel which includes three electrodes for each discharge cell. Such a three-electrode AC surface discharge type plasma display panel can be driven at a low voltage because the voltage required for a discharge operation is reduced using wall charges accumulated in electrode surfaces, and thus, has an advantage of a prolonged lifespan.

Driving of such a plasma display panel is carried out using a selective writing method or a selective erasing method, based on whether or not discharge cells selected in accordance with an address discharge thereof emit light.

In particular, the present invention relates to a method and apparatus for driving a plasma display panel in accordance with a selective erasing method, which can stabilize erasing address discharge during operation of the plasma display panel according to the selective erasing method, in order to prevent the occurrence of erroneous discharge, and thus, generation of bright defects.

In plasma display panels, VUV rays, which are generated in accordance with gas discharge carried out in the interior of a panel strike phosphors in the panel, thereby causing the phosphors to emit light. A structure of such a plasma display panel is illustrated in FIG. 1.

As shown in FIG. 1, the illustrated plasma display panel mainly includes a front substrate 10, a back substrate 20, and a plurality of discharge cells. Each discharge cell of the plasma display panel includes a scan electrode 11 (11a and 11b) and a sustain electrode 12 (12a and 12b) which are formed on the front substrate 10, and an address electrode 21 formed on the back substrate 20.

The scan electrode 11 and sustain electrode 12 include respective transparent electrodes 11a and 12a, and respective metal bus electrodes 11b and 12b each formed at one edge of the associated transparent electrode 11a or 12a. Each of the bus electrodes 11b and 12b has a line width narrower than that of the associated transparent electrode 11a or 12a. Generally, the transparent electrodes 11a and 12a are formed on the front substrate 10, using indium tin oxide (ITO). Generally, the metal bus electrodes 11b and 12b are formed on the transparent electrodes 11a and 12a, respectively, using a metal such as chromium (Cr), in order to reduce an increase in voltage caused by the transparent electrodes 11a and 12a which have a high resistance.

A dielectric layer 13 and a protective film 14 are sequentially laminated over the front substrate 10 to cover the scan electrode 11 and sustain electrode 12. Wall charges, which are generated during a discharge operation, are accumulated in the dielectric layer 13. The protective film 14 protects the dielectric layer 13 from a sputtering phenomenon generated during the discharge operation, and enhances the discharge efficiency of secondary electrons. Generally, the protective film 14 is made of magnesium oxide (MgO).

The address electrode 21 is formed on the back substrate 20 to cross the scan electrode 11 and sustain electrode 12. A dielectric layer 23 and a barrier wall 22 are sequentially formed on the address electrode 21. The barrier wall 22 extends parallel to the address electrode 21, to define the associated discharge cell. The barrier wall 22 functions to prevent VUV rays and visible rays generated during the discharge operation from being leaked to a discharge cell arranged adjacent to the discharge cell associated with the barrier wall 22.

A phosphor layer 24 is formed on the surfaces of the dielectric layer 23 and barrier wall 22. The phosphor layer 24 is excited by VUV rays generated during the discharge operation, thereby emitting light. Accordingly, the phosphor layer 24 generates a visible ray of one color selected from red, green, and blue, thereby displaying a color image.

An inert gas mixture, for example, HE+Xe, Ne+Xe, or He+Ne+Xe, is injected in a discharge space defined between the front substrate 10 and the back substrate 20, for display discharge.

In order to display an image with a desired gray level, the plasma display panel is driven by subfields. In this case, one frame is divided into several subfields SF respectively having different numbers of light emission stages. Each subfield is divided into a reset period for inducing uniform discharge, an address period for selecting desired discharge cells, and a sustain period for inducing a desired gray level in accordance with the number of discharges corresponding to the gray level.

When it is desired to display an image with 256 gray levels, one frame period (16.67 ms) corresponding to 1/60 of a second is divided into at least 8 subfields SF1 to SF8, as shown in FIG. 2. Also, each of the 8 subfields SF1 to SF8 is divided into a reset period, an address period, and a sustain period. The reset period and address period of each subfield are equal to those of the remaining subfields in the same frame, respectively. However, the sustain period of each subfield and the number of light emission stages generated in the sustain period of each subfield are different from those of the remaining subfields in the same frame, respectively, such that the number of light emission stages increases in a rate of 2ⁿ (provided, n=0, 1, 2, 3, 4, 5, 6, 7) from the first subfield SF1 to the final subfield SF8.

Since each frame has different subfield sustain periods and different numbers of light emission stages generated in respective subfield sustain periods, the frame is displayed at a desired gray level determined in accordance with accumulated sustain discharges of the subfields.

Driving of such a plasma display panel is carried out using a selective writing method or a selective erasing method in accordance with whether or not discharge cells selected in accordance with address discharge emit light.

In the selective writing method, all discharge cells are turned off in the reset period such that they are initialized. Discharge cells to be turned on are selected in the address period. The discharge cells selected in the address period are induced to generate discharge in the sustain period, thereby displaying an image. That is, ON cells are selected in the address period, and the ON cells selected by address discharge are induced to maintain discharge in the sustain period, thereby displaying an image.

Contrary to the selective writing method, the selective erasing method achieves display of an image by generating writing discharge on the entire screen portion of the panel such that all discharge cells are turned on, turning off selected cells in the address period, and generating discharge in the ON cells in the sustain period. That is, all discharge cells are turned on in an initial frame period. In a subsequent address period, selected discharge cells are turned off. Thereafter, in a subsequent sustain period, sustain discharge is generated in the discharge cells not selected in the address period, thereby displaying an image.

Generally, the selective writing method provides a gray level expression range wider than that of the selective erasing method, but has a drawback of an increased address period, as compared to the selective erasing method.

Practically, in the selective erasing method, full writing is carried out once for each frame, and turn-off of unnecessary discharge cells is subsequently carried out for every subfield of the frame.

For example, where one frame includes 10 subfields SF1 to SF10, as shown in FIG. 3, the first subfield SF1 includes a reset period, a full-writing period, an erasing address period, and a sustain period, whereas each of the remaining subfields SF2 to SF10 includes only an erasing address period and a sustain period.

FIG. 4 illustrates driving waveforms applied to a scan electrode Y and a sustain electrode Z of a plasma display panel in a sustain period where the plasma display panel is driven in accordance with a selective erasing method.

In a sustain period following the erasing address period, sustain pulses NSUS are alternately applied to the scan electrode Y and sustain electrode Z in each discharge cell. In this case, no discharge occurs in the OFF cells, in which erasing discharge has occurred in the erasing address period, even though sustain pulses NSUS are applied to the OFF cells. In accordance with the erasing discharge, the wall charges accumulated in each OFF cell are erased, thereby causing the wall voltage of the OFF cell to be weakened. As a result, although a sustain pulse NSUS is applied to the OFF cell, no discharge occurs in the OFF cell because the internal voltage of the OFF cell is lower than a discharge initiation voltage. That is, no sustain discharge occurs in the OFF cells, in which erasing discharge has occurred in the erasing address period.

On the other hand, in each ON cell, in which no erasing discharge has occurred in the address period, discharge occurs when a first sustain pulse NSUS is applied to the ON cell in the sustain period because the sum of the wall voltage of the ON cell and a sustain voltage Vs is higher than the discharge initiation voltage.

When discharge occurs in the ON cell, the wall charge polarities of the scan electrode Y and sustain electrode Z in the ON cell are inverted. Subsequently, sustain discharge occurs repeatedly in the ON cell in accordance with sustain pulses NSUS alternately applied to the scan electrode Y and sustain electrode Z of the ON cell. In every sustain discharge, of course, inversion of the wall charge polarities of the scan electrode Y and sustain electrode Z occurs.

In a final stage of the sustain period, a sustain pulse FSUS having a pulse width wider than that of the previously-applied sustain pulses NSUS is applied.

For example, it is assumed that the final sustain pulse FSUS is applied to the scan electrode Y. In this case, the sustain pulse finally applied to the sustain electrode Z is a general one, that is, the sustain pulse NSUS. When the sustain pulse NSUS is finally applied to the sustain electrode Z, wall charges having a positive polarity are formed in the scan electrode Y, whereas wall charges having a negative polarity are formed in the sustain electrode Z.

When the final sustain pulse FSUS having a pulse width wider than that of the sustain pluses NSUS is applied to the scan pulse Y, more intensive discharge occurs due to the wider pulse width of the final sustain pulse FSUS, thereby causing an increased amount of wall charges to be formed.

That is, wall charges are formed in the scan electrode Y in an amount more than the amount of wall charges formed upon the application of the sustain pulse NSUS preceding the final sustain pulse FSUS. Accordingly, an increased amount of negative wall charges and an increased amount of positive wall charges are formed in the scan electrode Y and the sustain electrode Z, respectively, as compared to those in the previous stage.

When a sufficient amount of wall charges are formed in the scan electrode Y and sustain electrode Z, as mentioned above, effective erasing discharge can occur in the next erasing address period. Accordingly, it is possible to accurately and reliably achieve the selection of OFF cells caused by erasing discharge.

However, although the final sustain pulse FSUS is set to have a wider pulse width, as mentioned above, it may be impossible to form a sufficient amount of wall charges required in the next erasing discharge.

Such a problem is associated with a time d, for which a low-level voltage is simultaneously applied to both the scan electrode Y and the sustain electrode Z in the sustain period, in which sustain pulses are alternately applied to the scan electrode Y and sustain electrode Z.

That is, when a low-level voltage is simultaneously applied to both the scan electrode Y and the sustain electrode Z, the positive and negative charges accumulated in the form of wall charges in the discharge cells are re-coupled with space charges. As a result, the amount of the wall charges is reduced.

Thus, when the time d, for which a low-level voltage is simultaneously applied to both the scan electrode Y and the sustain electrode Z, decreases, the reduction of wall charges is increased, so that subsequent erasing discharge may occur ineffectively.

When it is assumed that “d₁” is a simultaneous low-level voltage application period, for which a low-level voltage is simultaneously applied to both the scan electrode Y and the sustain electrode Z between successive sustain pulses NSUS respectively applied to the scan electrode Y and the sustain electrode Z before the final sustain pulse FSUS, the period d₁ is generally set to about 0.1 μs.

When it is also assumed that “NSUS′” represents a sustain pulse NSUS which is finally applied to one of the scan electrode Y and the sustain electrode Z other than the electrode, to which the final sustain pulse FSUS is applied, and “d₂” is a simultaneous low-level voltage application period between the point of time when the sustain pulse NSUS′ is applied and the point of time when the final sustain pulse FSUS is applied, the period d₂ is generally set to 1.0 μs or more.

Also, when it is assumed that the final sustain pulse FSUS is applied to the scan electrode Y, the period d₂, that is, the time interval between the point of time when the sustain pulse NSUS′ is applied to the sustain electrode Z and the point of time when the final sustain pulse FSUS is applied to the scan electrode Y, is set to 1.0 μs or more.

If the period d₂ increases, the reduction of wall charges caused when the low-level voltage is applied to the scan electrode Y and sustain electrode Z is also increased.

Accordingly, if an insufficient amount of wall charges are formed in the discharge cell, it is impossible to form wall charges in an amount required for the next erasing discharge even when the final sustain pulse FSUS is set to have a pulse width wider than that of other sustain pulses NSUS.

When an insufficient amount of wall charges are formed, the driving margin of the erasing discharge occurring in accordance with an erasing pulse in the next erasing address period is narrowed. In other words, in spite of application of the voltage of the erasing pulse, it is impossible to generate a voltage sufficient to generate erasing discharge. For this reason, the number of cells, in which no erasing discharge occurs, is increased.

As a result, no erasing discharge occurs in the discharge cells, each of which must perform erasing discharge in the erasing address period so as to be selected as an OFF cell. When no erasing discharge occurs in such an OFF cell, discharge occurs in the OFF cell in the sustain period, thereby causing a problem of erroneous discharge in the OFF cell, which must be maintained in an OFF state, and thus, generation of bright defects.

### SUMMARY OF THE INVENTION

The present invention has been made in view of the above-mentioned problems incurred in the related art, and an object of the invention is to stabilize erasing address discharge during operation of a plasma display panel according to a selective erasing method, thereby preventing the occurrence of erroneous discharge causing generation of bright defects.

Another object of the invention is to provide a method and apparatus for driving a plasma display panel, in which the time interval between a final sustain pulse finally applied in a sustain period and a sustain pulse immediately preceding the final sustain pulse is set to be within 1.0 μs, thereby being capable of reducing the amount of wall discharges erased during a period in which a low-level voltage is simultaneously applied to scan and sustain electrodes.

In accordance with one aspect, the present invention provides a method for driving a plasma display panel, comprising the steps of: applying sustain pulses to a first electrode and a second electrode; and controlling a time interval between a final one of the sustain pulses applied to the first electrode and a final one of the sustain pulses applied to the second electrode such that the time interval is 0.1 μs to 1.0 μs.

The time interval may correspond to a time interval between a rising start point of the final sustain pulse applied to the first electrode and a falling end point of the final sustain pulse applied to the second electrode, to lower a reduction in the amount of wall charges occurring during application of a low-level voltage to both the first electrode and the second electrode.

In accordance with another aspect, the present invention provides an apparatus for driving a plasma display panel, comprising: a driver for applying sustain pulses to a first electrode and a second electrode; and a controller for controlling a time interval between a final one of the sustain pulses applied to the first electrode and a final one of the sustain pulses applied to the second electrode such that the time interval is 0.1 μs to 1.0 μs.

Since the time interval between the final sustain pulse applied to the first electrode and the final sustain pulse applied to the second electrode is within 1.0 μs, it is possible to reduce the amount of wall charges erased during application of a low-level voltage.

Accordingly, a sufficient amount of wall charges are formed in accordance with a discharge occurring when the final sustain pulse is applied to the first electrode, so that the driving margin of the erasing discharge occurring in the next erasing address period is widened. Thus, it is possible to prevent the occurrence of erroneous discharge in OFF cells, and thus, generation of bright defects.

### BRIEF DESCRIPTION OF THE DRAWINGS

The above objects, and other features and advantages of the present invention will become more apparent after reading the following detailed description when taken in conjunction with the drawings, in which:

FIG. 1 is a perspective view illustrating a discharge cell structure of a conventional three-electrode AC surface discharge type plasma display panel;

FIG. 2 is a diagram illustrating an example of a frame split for a display;

FIG. 3 is a diagram illustrating a frame split to be driven in accordance with a conventional selective erasing method;

FIG. 4 is a waveform diagram illustrating driving waveforms applied in a final stage of a sustain period in accordance with the conventional selective erasing method;

FIG. 5 is a waveform diagram illustrating driving waveforms applied in a sustain period in a selective erasing method according to a first embodiment of the present invention;

FIG. 6 is a waveform diagram illustrating driving waveforms applied in a sustain period in a selective erasing method according to a second embodiment of the present invention;

FIG. 7 is a waveform diagram illustrating driving waveforms applied in a sustain period in a selective erasing method according to a third embodiment of the present invention;

FIG. 8 is a waveform diagram illustrating driving waveforms applied in a sustain period in a selective erasing method according to a fourth embodiment of the present invention;

FIG. 9 is a waveform diagram illustrating driving waveforms applied in a sustain period in a selective erasing method according to a fifth embodiment of the present invention;

FIG. 10 is a block diagram illustrating an apparatus for driving a plasma display panel in accordance with the present invention.

FIG. 11 is a circuit diagram illustrating a plasma display panel driving circuit included in the driving apparatus according to the present invention; and

FIG. 12 is a timing diagram illustrating driving waveforms and switch element control signals applied in a sustain period in the driving apparatus when the selective erasing method according to the first embodiment of the present invention is applied to the driving apparatus.

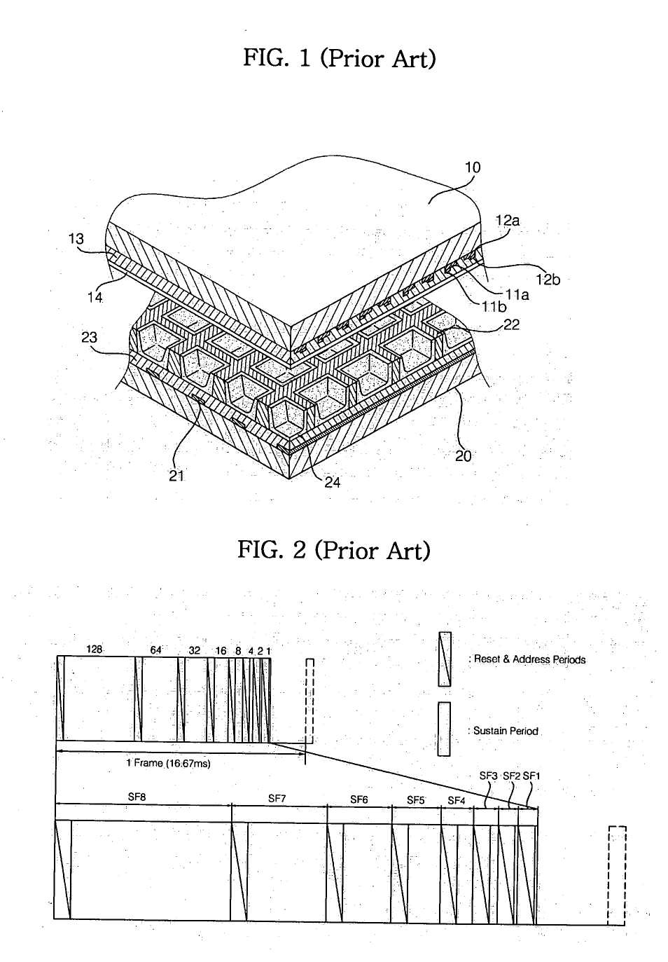

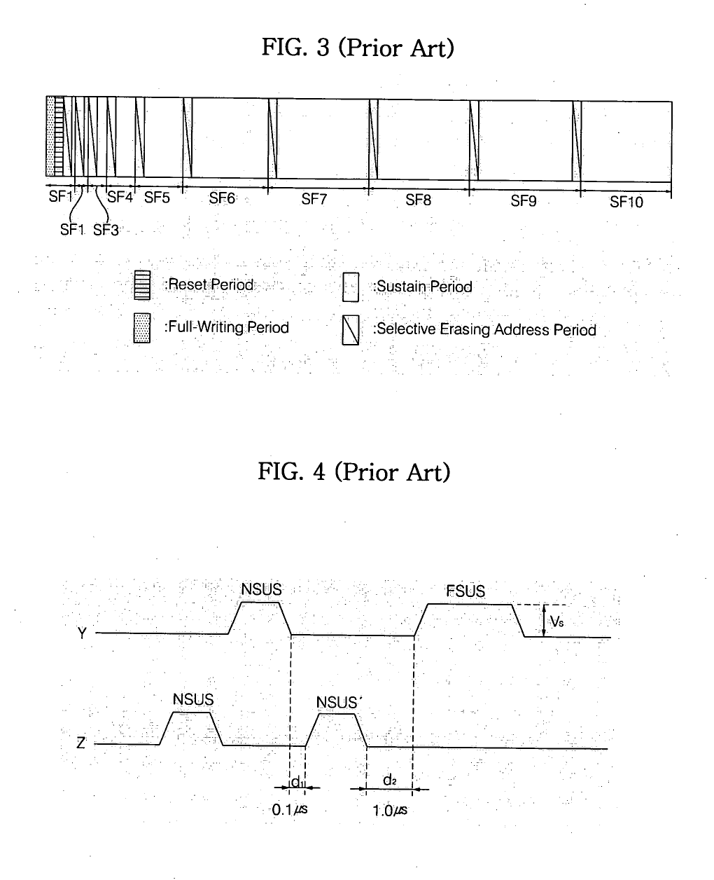

### DESCRIPTIO OF THE PREFERRED EMBODIMENTS

Now, embodiments of a method and apparatus for driving a plasma display panel in accordance with the present invention will be described in detail with reference to the annexed drawings. Although there may be various embodiments associated with the method and apparatus for driving a plasma display panel in accordance with the present invention, the following description will be given in conjunction with the most preferred embodiment. In the following description, detailed description of basic configurations of the plasma display panel driving method and apparatus according to the present invention will be omitted because those configurations are identical to those of the above-mentioned related art.

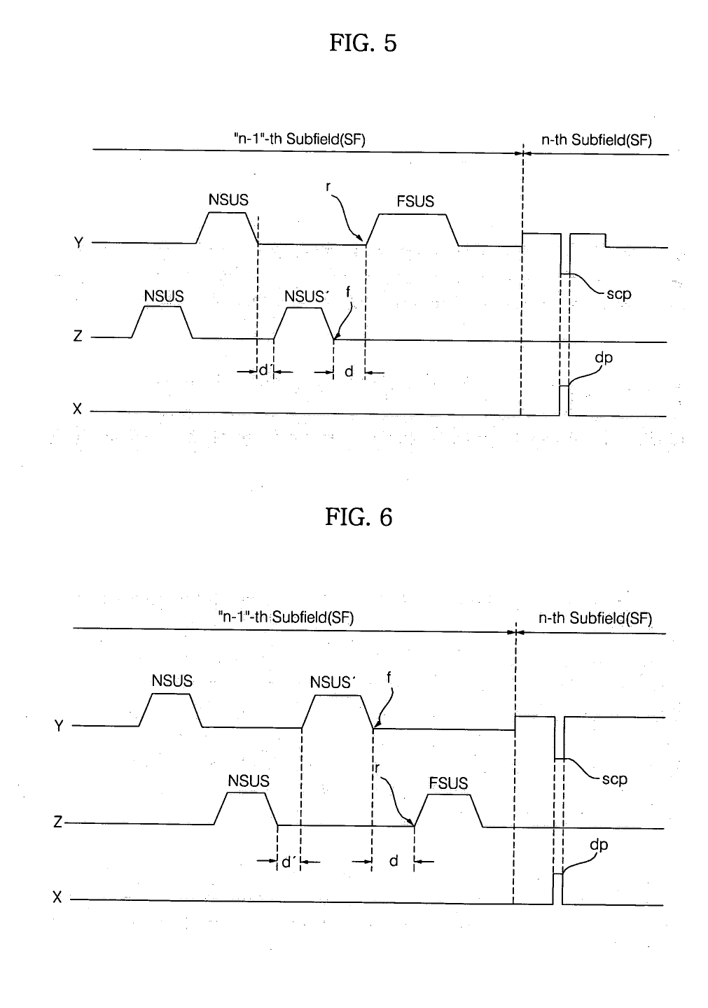

FIGS. 5 to 7 are timing diagrams illustrating driving waveforms and a switching element control signal applied in a sustain period in a method for driving a plasma display panel using a selective erasing method in accordance with various embodiments of the present invention, respectively. Hereinafter, the method for driving a plasma display panel using a selective erasing method in accordance with one illustrated embodiment of the present invention will be described with reference to FIG. 5.

In the plasma display panel driving method according to the embodiment of the present invention illustrated in FIG. 5, each frame period is divided into a plurality of subfields SF, each of which is driven in a time-division manner in accordance with a selective erasing method.

Each subfield SF includes an address period for selecting OFF cells, and a sustain period for generating sustain discharge in ON cells.

In the selective erasing method, full writing is carried out once for each frame, and turn-off of unnecessary discharge cells is subsequently carried out for every subfield SF of the frame. That is, the first subfield includes a reset period for initializing all discharge cells, a full-writing period, an erasing address period for erasing OFF cells, and a sustain period for causing discharge in ON cells. Each of the remaining subfields includes a reset period, an address period for selecting OFF cells, and a sustain period for causing sustain discharge in ON cells, without including a full-writing period.

In the address period, erase of wall charges is carried out for the OFF cells, in which no discharge will occur during the sustain period. In order to generate erasing discharge in the address period, as shown in FIG. 5, erasing scan pulses scp having a negative polarity are sequentially applied to a scan electrode Y of each OFF cell. In sync with the erasing scan pulses scp, erasing data pulses dp having a positive polarity are applied to an address electrode X of each OFF cell.

In each OFF cell, to which the erasing scan pulse scp and erasing data pulse dp are applied, erasing discharge occurs when the sum of the voltage difference between the erasing scan pulse scp and the erasing data pulse dp and the wall voltage generated in the reset period is higher than a discharge initiation voltage.

In accordance with the erasing discharge, wall charges having a negative polarity formed in the scan electrode Y of each OFF cell and wall charges having a positive polarity formed in the sustain electrode Z are reduced. Even when sustain pulses are applied to the cells, from which wall charges have been erased, no discharge occurs in the cells because the voltage difference between the scan electrode Y and the sustain electrode Z is less than the discharge initiation voltage.

On the other hand, in each ON cell, in which no erasing discharge has occurred in the address period, the negative wall charges formed in the scan electrode Y of the ON cell and the positive wall charges formed in the sustain electrode Z of the ON cell are maintained. In this case, accordingly, when a sustain pulse is applied to the ON cell, discharge occurs in the ON cell because the sum of the sustain voltage and the wall voltage between the scan electrode Y and the sustain electrode Z is higher than the discharge initiation voltage. When sustain discharge occurs in the ON cell, the polarities of the wall charges formed in the scan electrode Y and sustain electrode Z are inverted due to the discharge.

In detail, sustain pulses NSUS are alternately applied to the scan electrode Y and sustain electrode Z in the sustain period. In accordance with the illustrated embodiment of the present invention, the time interval d between the final sustain pulse FSUS applied to the scan electrode Y in the final stage of the sustain period and the sustain pulse NSUS′ applied to the scan electrode Y immediately before the final sustain pulse FSUS is set to be in a range of 0.1 μs to 0.5 μs.

Generally, the final sustain pulse FSUS applied in the final stage of the sustain period has a pulse width wider than that of the sustain pulses NSUS and sustain pulse NSUS′ preceding the final sustain pulse FSUS.

For example, when it is assumed that the final sustain pulse FSUS is applied to the scan electrode Y, the sustain pulse NSUS′, which has a normal pulse width, is finally applied to the sustain electrode Z.

In this case, in accordance with the application of the sustain pulse NSUS′ having a normal pulse width to the sustain electrode Z, positive wall charges are formed in the scan electrode Y, and negative wall charges are formed in the sustain electrode Z.

When the final sustain pulse FSUS having a pulse width wider than that of the sustain pulse NSUS′ is applied to the scan electrode Y, more intensive discharge occurs in the scan electrode Y due to the wider pulse width of the final sustain pulse FSUS, thereby causing an increased amount of wall charges to be formed.

That is, an increased amount of negative wall charges and an increased amount of positive wall charges are formed in the scan electrode Y and the sustain electrode Z, respectively, as compared to those in the previous sustain discharge stages.

When a sufficient amount of wall charges are formed in the scan electrode Y and sustain electrode Z, as described above, effective erasing discharge can occur in the next erasing address period. Accordingly, it is possible to accurately and reliably achieve the selection of OFF cells caused by erasing discharge.

In the plasma display panel driving method according to the illustrated embodiment of the present invention, the time interval d between the final sustain pulse FSUS applied in the final stage of the sustain period and the sustain pulse NSUS′ applied immediately before the final sustain pulse FSUS is set to be within 1.0 μs. Preferably, the time interval d is 0.1 μs to 0.5 μs.

The time interval d corresponds to a time interval between a rising start point r of the final sustain pulse FSUS applied to the scan electrode Y and a falling end point f of the sustain pulse NSUS′ finally applied to the sustain electrode Z.

The voltage level at the rising start point r is within a range from the low voltage level of the sustain pulse FSUS to 5% of the high voltage level of the sustain pulse FSUS. The voltage level at the falling end point f is within a range from the low voltage level of the sustain pulse NSUS′ to 5% of the high voltage level of the sustain pulse NSUS′.

In accordance with the present invention, the time interval d does not exceed 1.0 μs, differently from the conventional case in which the time interval d is not less than 1.0 μs. Accordingly, it is possible to reduce the period, for which a low-level voltage is simultaneously applied to both the scan electrode Y and the sustain electrode Z, thereby lowering the reduction of wall charges formed in the scan electrode Y and sustain electrode Z.

As a result, no reduction in the wall voltage between the scan electrode Y and the sustain electrode Z occurs. Thus, stable sustain discharge occurs when the final sustain pulse FSUS is applied. Also, since the pulse width of the final sustain pulse FSUS is large, a sufficient amount of wall charges is formed in the scan electrode Y and sustain electrode Z.

Accordingly, the driving margin of the erasing discharge occurring in the next erasing address period is widened. In other words, there is no occurrence of a phenomenon wherein discharge cannot occur in spite of application of erasing scan pulses scp and erasing data pulses dp, due to a reduction in the amount of wall charges formed in the scan electrode Y and sustain electrode Z. Therefore, it is possible to prevent occurrence of a phenomenon wherein no erasing discharge occurs in the discharge cells, each of which must be selected as an OFF cell in the next erasing address period, and discharge occurs in the OFF cell in the next sustain period, thereby causing the occurrence of erroneous discharge in the OFF cell, and thus, generation of bright defects.

Also, the time interval d between the final sustain pulse FSUS and the sustain pulse NSUS′ immediately preceding the final sustain pulse FSUS is more than the time interval d′ between successive sustain pulses NSUS respectively applied before the sustain pulses NSUS′ and FSUS.

Generally, the time interval d′ between successive sustain pulses NSUS, which are applied to the scan electrode Y and sustain electrode Z, and are neither the final sustain pulse FSUS applied to the scan electrode Y nor the sustain pulse NSUS′ finally applied to the sustain electrode Z, is set to be on the order of 0.1 μs.

Also, where the final sustain pulse FSUS is applied to the sustain electrode Z, as shown in FIG. 6, the time interval d between the final sustain pulse FSUS applied to the sustain electrode Z and the sustain pulse NSUS′ finally applied to the scan electrode Y is set to be within a range of 0.1 μs to 1.0 μs.

In this case, the period, for which a low-level voltage is simultaneously applied to both the scan electrode Y and the sustain electrode Z, is reduced, thereby lowering the reduction of wall charges in the scan electrode Y and sustain electrode Z occurring during the application of the low-level voltage, similarly to the above-described case.

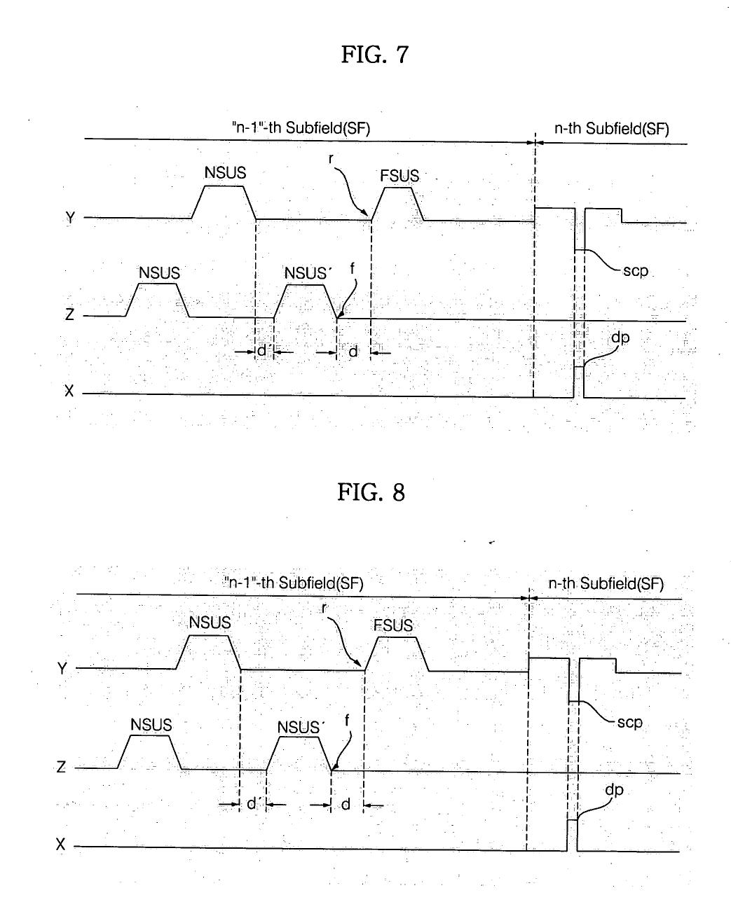

As shown in FIG. 7, the pulse width of the final sustain pulse FSUS applied in the final stage of the sustain period may be narrower than the pulse width of the sustain pulse NSUS′ applied immediately before the final sustain pulse FSUS.

Also, as shown in FIG. 8, the pulse width of the final sustain pulse FSUS may be equal to the pulse width of the sustain pulse NSUS′ applied immediately before the final sustain pulse FSUS.

In the case of FIG. 7 or 8, the time interval d between the final sustain pulse FSUS applied to the sustain electrode Z and the sustain pulse NSUS′ finally applied to the scan electrode Y is also set to be within a range of 0.1 μs to 1.0 μs.

That is, although the pulse width of the final sustain pulse FSUS is narrower than or equal to the pulse width of the sustain pulse NSUS′ applied immediately before the final sustain pulse FSUS, the reduction in wall charges occurring during the application of the low-level voltage to the scan electrode Y and sustain electrode Z is lowered as long as the time interval d is within 1.0 μs.

Since the reduction in wall charges during the application of the low-level voltage is low, the reduction in the wall voltage between the scan electrode Y and the sustain electrode Z is low. Accordingly, stable sustain discharge can occur when the final sustain pulse FSUS, which has a pulse width equal to or narrower than that of the normal sustain pulses NSUS, is applied.

Also, since wall charges are formed in the scan electrode Y and sustain electrode Z during the period of the final sustain pulse FSUS, erasing discharge will occur in the next address period in accordance with application of the erasing data pulses dp and erasing scan pulses scp.

The application of the sustain pulse FSUS having a pulse width different from that of the normal sustain pulses NSUS may be carried out one or more times.

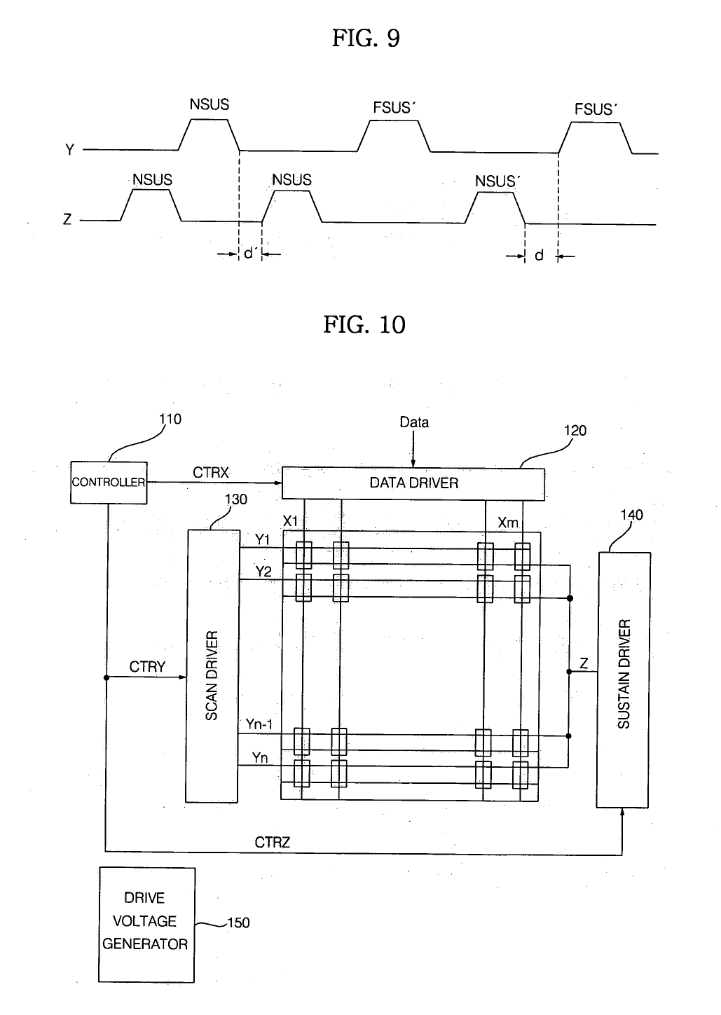

For example, when it is assumed that “FSUS′” represents a sustain pulse applied in the final stage of the sustain period, the sustain pulse FSUS′ is applied to the scan electrode Y, sustain pulses NSUS are alternately applied to the scan electrode Y and sustain electrode Z in the sustain period, and the sustain pulse FSUS′ has a pulse width different from that of the sustain pulses NSUS, the sustain pulse FSUS′ may be applied to the scan electrode Y two times, as shown in FIG. 9.

In this case, the normal sustain pulses NSUS are applied to the sustain electrode Z.

Identically to the above-described cases, in this case, the time interval d between each sustain pulse FSUS′ applied to the scan electrode Y and the sustain pulse NSUS applied to the sustain electrode Z immediately before the sustain pulse FSUS′ is set to be within a range of 0.1 μs to 1.0 μs.

The less the time interval d, the less the reduction of wall charges occurring during the application of the low-level voltage. Accordingly, no erasing discharge occurs in each OFF cell in the next address period, so that it is possible to prevent the occurrence of erroneous discharge, and thus, generation of bright defects.

Hereinafter, an apparatus for driving a plasma display panel in accordance with the present invention will be described with reference to FIGS. 10 to 12.

As shown in FIG. 10, the plasma display panel driving apparatus according to the present invention includes a data driver 120, which applies data to address electrodes X1 to Xm, a scan driver 130 for driving scan electrodes Y1 to Yn, a sustain driver 140 for driving sustain electrodes Z, a controller 110 for controlling the drivers 120, 130, and 140, and a drive voltage generator 150 for supplying, to the drivers 120, 130, and 140, drive voltages respectively required for the drivers 120, 130, and 140.

In response to a timing control signal from the controller 11, the data driver 120 samples data, latches the sampled data, and supplies the latched data to the address electrodes X1 to Xm (hereinafter, simply referred to as an “address electrode X”).

The scan driver 130 supplies sustain pulses to the scan electrodes Y1 to Yn (hereinafter, simply referred to as a “scan electrode Y”) under the control of the controller 110. The sustain driver 140 supplies sustain pulses to the sustain electrodes Z (hereinafter, simply referred to as a “sustain electrode Z”) under the control of the controller 110. The scan driver 130 and sustain driver 140 operate alternately under the control of the controller 110.

The controller 110 receives vertical/horizontal sync signals and clock signals, and generates timing control signals CTRX, CTRY, and CTRZ respectively required for the drivers 120, 130, and 140, based on the received signals. The controller 110 sends the timing control signals CTRX, CTRY, and CTRZ to the associated drivers 120, 130, and 140, respectively, in order to control the drivers 120, 130, and 140.

The data control signal CTRX includes a sampling clock signal for sampling of data, a latch control signal, and a switch control signal for control of ON/OFF timing of an energy recovery circuit and driving switch elements which are included in the data driver 120.

The scan control signal CTRY includes a switch control signal for control of ON/OFF timing of an energy recovery circuit and driving switch elements which are included in the scan driver 130. Also, the sustain control signal CTRZ includes a switch control signal for control of ON/OFF timing of an energy recovery circuit and driving switch elements which are included in the sustain driver 140.

The drive voltage generator 150 generates voltages required for the drivers 120, 130, and 140, that is, a sustain voltage Vs, an address voltage for data pulses, a scan voltage for scan pulses, and the like.

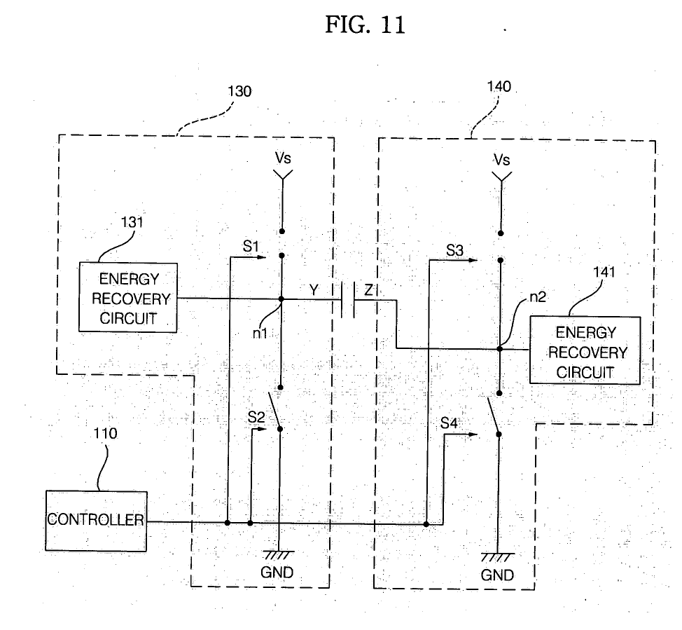

FIG. 11 is a circuit diagram illustrating the circuit configurations of the scan driver 130 and sustain driver 140 in the plasma display panel driving apparatus according to the present invention.

The scan driver 130 includes an energy recovery circuit 131, a first switch element S1, and a second switch element S2. The sustain driver 140 includes an energy recovery circuit 141, a third switch element S3, and a fourth switch element S4.

The energy recovery circuits 131 and 141 respectively included in the scan driver 130 and sustain driver 140 recover the energy of reactive power not contributing to discharge from the plasma display panel, and charge the scan electrode Y or sustain electrode Z, using the recovered energy. The energy recovery circuits 131 and 141 may be implemented using well-known energy recovery circuits.

The first switch element S1 is connected between a source of the sustain voltage Vs and the plasma display panel. The first switch element S1 supplies the sustain voltage Vs to the scan electrode Y via a first node n1 under the control of the controller 110.

The second switch element S2 is connected between a source of a ground voltage GND and the plasma display panel. The second switch element S2 supplies the ground voltage GND to the scan electrode Y via the first node n1 under the control of the controller 110.

The third switch element S3 is connected between the source of the sustain voltage Vs and the plasma display panel. The third switch element S3 supplies the sustain voltage Vs to the sustain electrode Z via a second node n2 under the control of the controller 110.

The fourth switch element S4 is connected between the source of the ground voltage GND and the plasma display panel. The fourth switch element S4 supplies the ground voltage GND to the sustain electrode Z via the second node n2 under the control of the controller 110.

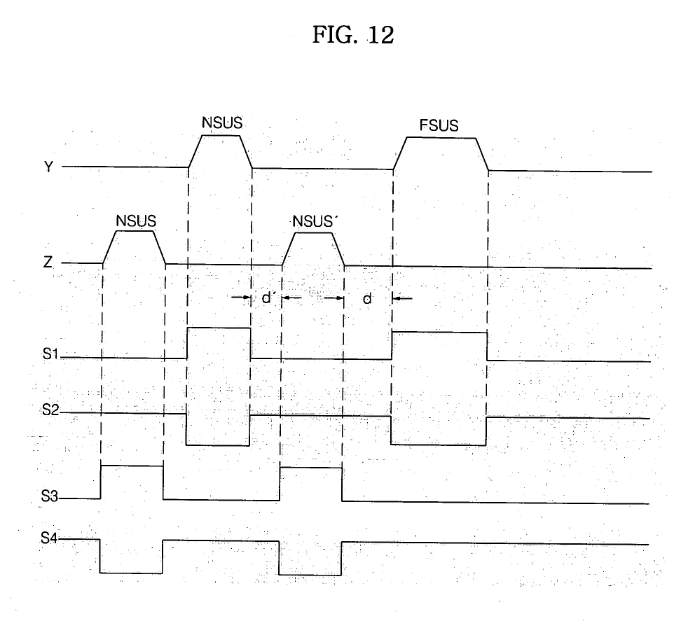

The first through fourth switch elements S1, S2, S3, and S4 operate in response to switch control signals shown in FIG. 12, respectively.

As shown in FIG. 12, when a high pulse is applied to the first switch S1, a sustain pulse NSUS is applied to the scan electrode Y. On the other hand, when a high pulse is applied to the third switch S3, the sustain pulse NSUS is applied to the sustain electrode Z.

When a high pulse is applied to the second switch S2, a low-level voltage, namely, the ground voltage, is applied to the scan electrode Y. On the other hand, when a high pulse is applied to the fourth switch S4, the low-level voltage, namely, the ground voltage, is applied to the sustain electrode Z.

When the first and third switches S1 and S3 are alternately turned on/off, the sustain pulses NSUS are alternately applied to the scan electrode Y and sustain electrode Z.

The controller 110 controls the time interval between the point of time when the first switch S1 is turned off and the point of time when the third switch S3 is turned on, and the time interval between the point of time when the third switch S3 is turned off and the point of time when the first switch S1 is turned on, such that each of the time intervals correspond to about 0.1 μs. In FIG. 12, the time intervals are designated by “d′”.

In particular, for application of a final sustain pulse FSUS having a pulse width wider than that of normal sustain pulses NSUS to the scan electrode Y in the final stage of a sustain period, the controller 110 performs a control operation such that the first switch S1 is turned on within a time of 0.1 μs to 1.0 μs after the turn-off of the third switch S3. Thus, the sustain voltage Vs is applied to the scan electrode Y.

On the contrary, when the final sustain pulse FSUS must be applied to the sustain electrode Z, the controller 110 performs a control operation such that the third switch S3 is turned on within a time of 0.1 μs to 1.0 μs after the turn-off of the first switch S1. Thus, the sustain voltage Vs is applied to the sustain electrode Z.

Thus, the controller 110 controls the ON/OFF timing of the switch elements S1 and S3 prior to the application of the final sustain pulse FSUS to lower the reduction in wall charges formed in the scan electrode Y and sustain electrode Z in a period, for which the low-level voltage, namely, the ground voltage, is applied to both the scan electrode Y and the sustain electrode Z.

Accordingly, a sufficient amount of wall charges are formed in accordance with sustain discharge occurring when the final sustain pulse FSUS is applied, so that erasing discharge occurs reliably in OFF cells.

In other words, there is no occurrence of a phenomenon wherein erasing discharge cannot occur in the OFF cells in an address period due to an insufficient wall voltage. Therefore, it is possible to prevent the occurrence of erroneous discharge in the OFF cells, and thus, generation of bright defects.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A method for driving a plasma display panel, comprising the steps of:
applying sustain pulses to a first electrode and a second electrode; and
controlling a time interval between a final one of the sustain pulses applied to the first electrode and a final one of the sustain pulses applied to the second electrode such that the time interval is 0.1 μs to 1.0 μs.

2. The method according to claim 1, wherein the time interval corresponds to a time interval between a rising start point of the final sustain pulse applied to the first electrode and a falling end point of the final sustain pulse applied to the second electrode.

3. The method according to claim 2, wherein the final sustain pulse applied to the first electrode has, at the rising start point, a voltage level ranging from a low voltage level of the sustain pulses to 5% of a high voltage level of the sustain pulses.

4. The method according to claim 2, wherein the final sustain pulse applied to the second electrode has, at the falling end point, a voltage level ranging from a low voltage level of the sustain pulses to 5% of a high voltage level of the sustain pulses.

5. The method according to claim 1, wherein the time interval is controlled to be within a range of 0.1 μs to 0.5 μs.

6. The method according to claim 1, where the final sustain pulse applied to the first electrode has a pulse width wider than a pulse width of the final sustain pulse applied to the second electrode.

7. The method according to claim 1, wherein the final sustain pulse applied to the first electrode has a pulse width different from pulse widths of the sustain pulses applied before the final sustain pulse applied to the first electrode.

8. The method according to claim 1, wherein the first electrode is a scan electrode.

9. The method according to claim 1, wherein the first electrode is a sustain electrode.

10. The method according to claim 1, wherein the time interval is more than a time interval between successive ones of the sustain pulses which are applied to the first and second electrodes, respectively, and are neither the final sustain pulse applied to the first electrode nor the final sustain pulse applied to the second electrode.

11. An apparatus for driving a plasma display panel, comprising:
a driver for applying sustain pulses to a first electrode and a second electrode; and
a controller for controlling a time interval between a final one of the sustain pulses applied to the first electrode and a final one of the sustain pulses applied to the second electrode such that the time interval is 0.1 μs to 1.0 μs.

12. The apparatus according to claim 11, wherein the driver comprises:
a scan driver for applying sustain pulses to a scan electrode in a sustain period; and
a sustain driver for applying sustain pulses to a sustain electrode while operating alternately with the scan driver.

13. The apparatus according to claim 12, wherein:
the scan driver comprises an energy recovery circuit, a first switch element, and a second switch element; and
the sustain driver comprises an energy recovery circuit, a third switch element, and a fourth switch element.

14. The apparatus according to claim 11, wherein the time interval corresponds to a time interval between a rising start point of the final sustain pulse applied to the first electrode and a falling end point of the final sustain pulse applied to the second electrode.

15. The apparatus according to claim 11, wherein the controller controls the time interval to be within a range of 0.1 μs to 0.5 μs.

16. The apparatus according to claim 14, wherein the controller controls ON/OFF timing of the first and third switch elements to control the time interval.

17. The apparatus according to claim 11, where the final sustain pulse applied to the first electrode has a pulse width wider than a pulse width of the final sustain pulse applied to the second electrode.

18. The apparatus according to claim 11, wherein the controller controls the time interval to be is more than a time interval between successive ones of the sustain pulses which are applied to the first and second electrodes, respectively, and are neither the final sustain pulse applied to the first electrode nor the final sustain pulse applied to the second electrode.
